(19) United States
(12) Patent Application Publication
(10) Pub. No.: US 2019/0258610 A1
(43) Pub. Date: Aug. 22, 2019

(54) BYZANTINE FAULT-TOLERANT ALGORITHM WITH FOUR STEPS

(71) Applicant: Wei Kang Tsai, (US)

(72) Inventors: Enyan Dang, Irvine, CA (US); Wei-Tek Tsai, Irvine, CA (US); Wei Kang Tsai, Irvine, CA (US)

(21) Appl. No.: 16/281,119

(22) Filed: Feb. 21, 2019

Related U.S. Application Data
(60) Provisional application No. 62/633,546, filed on Feb. 21, 2018.

(51) Int. Cl. G06F 16/182; G06F 11/07; H04L 9/06; H04L 9/32

(52) U.S. Cl. CPC G06F 16/182; G06F 11/0709; H04L 2209/38; H04L 9/3247; H04L 9/0643

(57) ABSTRACT

A method of adding a new block to a blockchain system with a plurality of system nodes, with the purpose of recording a set of submitted transactions in the face of Byzantine faults, based on data consistency among the system nodes. Upon receiving a set of submitted transactions (this set of transactions to be recorded in a new block in the blockchain), each system node generates a digital representation of the set of submitted transactions. The digital representations at the system nodes are made consistent among the system nodes, thereby a submitted transaction is determined to be included in the new block based on the synchronized digital representations at the system nodes.

### CROSS REFERENCES TO RELATED APPLICATIONS

The present Application claims priority to U.S. Provisional Patent Application No. 62/633,546, entitled “A Method of Block Building Based on Byzantine Consensus via Four Rounds of Communication,” filed on Feb. 21, 2018, which is hereby incorporated by reference in its entirety.

### FIELD OF THE INVENTION

The present invention relates to methods of building blockchains based on data consistency among the participating nodes, in particular to blockchain building methods under Byzantine faults.

### BACKGROUND OF THE INVENTION

In a blockchain system with a plurality of system nodes, each node maintains a blockchain. To ensure consistency of data at all nodes, it is necessary to ensure the blockchain maintained by each node being the same. With rapid development of distributed applications such as e-commerce, a blockchain system may suffer attacks and faults, resulting in the presence of “traitor nodes” among “loyal” normal nodes. Therefore, there is a need to maintain data consistency in a blockchain system in a fault-tolerant manner Towards this goal, the faults to be tolerated include both benign faults and Byzantine faults, while data consistency is maintained among all “loyal” normal nodes. With the present invention, there is provided a 4-step Byzantine algorithm to keep data consistent among all normal “loyal” nodes in a blockchain system, in the face of various faults, including Byzantine faults.

A change in a blockchain system is caused by a set of submitted transactions to the system. At the writing of the present invention, the process of adding blocks into a blockchain system is often by means of “mining.” For example, Bitcoin and Ethereum are 2 such systems employing “mining” for adding a block. In these methods, usually a block of the fastest node among all nodes is accepted by all nodes. All nodes may also accept the longest chain to ensure data consistency among the system nodes. However, “mining” itself is a meaningless calculation that wastes much resources. In a blockchain system, a single Byzantine fault at a system node can cause data inconsistency among normal nodes. Since a blockchain system is a distributed ledger or record system, a Byzantine fault may lead to economic losses in the entities that rely on the blockchain system as a ledger or record system. Further, a critical benefit of blockchain systems is immutability of data. Therefore, it is critical to maintain immutability of data, or specifically, immutability of data stored in normal system nodes, when the system is under attack of various sorts.

### BRIEF SUMMARY OF THE INVENTION

Aspects of the present invention relate to providing methods for building or adding a block to a blockchain at a system node of a blockchain system, whereby data stored in the blockchain system remain consistent, in the face of Byzantine faults and malicious attacks of various sorts.

In one embodiment, a blockchain building method in a blockchain system comprises the following 4 steps, performed by nodes of the blockchain system:

Step (1): Transaction confirmation: upon receiving a set of submitted (requested) transactions (this set of transactions to be recorded in a new block in the blockchain system), each node generates an initial digital representation of the set of submitted transactions. In one embodiment, the digital representation is a bit-array, and each node sends the generated bit-array to all other nodes in the system. From the bit-array (or digital representation), each node has means to determine if a transaction is included in the set of submitted transactions. Each node, upon receiving bit-arrays (or digital representations) sent from other nodes, modifies its bit-array (or digital representation), based on a majority rule, to generate its new digital representation (or bit-array). An exemplary rule is based on ⅔ majority: at each node, if a transaction is indicated by at least ⅔ portion of all nodes in the system via the received bit-arrays (or digital representations) and its own bit-array (or digital representation), the transaction is indicated in the new bit-array (or digital representation) at the node; otherwise the transaction is not indicated in the new bit-array (or digital representation) at the node. At each node, after the modifications based on received bit-arrays (or digital representations) from a sufficient number of other nodes, the newly modified bit-array (or digital representation) at each node is said to be the new-transactions bit-array (or digital representation) at the node, or the new-block bit-array (or digital representation) at the node.

Step (2): Building and sending a new block: each node in the system performs a leader selection algorithm; after executing the selection algorithm, each node in the system knows whether or not it has become the leader for the set of submitted transactions. The leader node then builds a new block according to the submitted transactions it has received, and sends the new block to all remaining nodes in the system.

Step (3): First round of validation voting: upon receiving the new block sent by the leader node, each node validates the new block based on its new-block bit-array (or digital representation) and the new block received from the leader node, and sends a vote to all other nodes in the system, the vote comprising its vote (for example, “1” for yes, “0” for no), a hash value indicating the new block received from the leader, and its own digital signature. The votes sent in step (3) are referred to the first-round votes.

Step (4): Second round of validation voting: after receiving first-round votes from a sufficient number of nodes in the system, each node sends a second-round vote to all other nodes in the system, the second-round vote comprising all the first-round votes received at the node, plus its own digital signature; after receiving a sufficient number of second-round votes from other nodes in the system, each node decides to accept the new block or not based on the second-round votes received from a sufficient number of nodes in the system.

### BRIEF DESCRIPTION OF THE DRAWINGS

The above and other objects and features in accordance with the present invention will become apparent from the following descriptions of embodiments in conjunction with the accompanying drawings, and in which:

FIG. 1 is a simplified illustration that shows 4 rounds of communication in a blockchain system, in one exemplary embodiment of the present invention.

FIG. 2 is a simplified illustration that shows a transaction is indicated in a bit-array (or digital representation) at a node of a blockchain system, in one exemplary embodiment of the present invention.

FIG. 3 is a simplified illustration of a message indicating a first-round vote sent from a node in a blockchain system, in one exemplary embodiment of the present invention.

FIG. 4 is a simplified illustration of a message indicating a second-round vote sent from a node in a blockchain system, in one exemplary embodiment of the present invention.

### DETAILED DESCRIPTION OF EXEMPLARY EMBODIMENTS

In accordance with one embodiment of the present invention, a decision about adding a new block in a blockchain system is determined by a majority rule. An exemplary rule of the majority rule is that if at least a fixed (say p) portion of all the nodes in the system agrees on a decision, then the decision is accepted by all normal (non-malicious or non-faulty) nodes in the system. In one embodiment, p is set to be ⅔ in the rule. In one embodiment, if a node determines that more than ⅔ portion of all nodes in the system agrees that a particular transaction is included in a set of submitted transaction, then the node accepts that the transaction is included in the set; otherwise, the transaction is rejected in the set. In yet another embodiment, if a node determines that more than ¾ portion of all nodes in a blockchain system has validated a new block sent by a leader block in the system, the node accepts the new block and adds the new block to the blockchain stored at the node. The number p is selected to suit various system purposes.

A process of building a new block to a blockchain system can fail for various reasons. For example, if the number of normal nodes in the system accepting a new block addition is less than a fixed portion, then the current round of construction the new block is considered to have failed, and a new round of construction will be started. When such a failure occurs, the height of the chain does not increase.

When an abnormal (faulty) node in a blockchain system becomes normal, the node will be synchronized with the blockchain system via a synchronization mechanism. The node may request to one or more normal nodes in the system to obtain a complete blockchain. This is to ensure any node in the system can participate in a new round of building after returning to the normal state, thereby maintaining consistency of data in the system and integrity of each node's data.

All nodes in a blockchain system use digital signatures in voting processes, thereby each message from a different node in the system is identifiable and authenticated to have come from the indicated sending node. In one embodiment, each node encrypts a vote and the hash value of a new block with a digital signature, wherein the digital signature is generated with its own private key. The digital signature is sent along with voting information to all other nodes in the system. In one embodiment, after receiving a digitally signed voting message, each node uses the sender's public key to decrypt the digital signature to authenticate the voting message and to obtain pre-encrypted information. If the digital signature is authenticated by the decryption process, the received voting message is considered to be validated. In one embodiment, all nodes must ensure that a received voting message is non-repudiated via the digital signature contained in the message.

In one embodiment of step (1), the initial digital representation generated by each node of a blockchain system is a bit-array. In one embodiment, a transaction is indicated by a bit in the bit-array at a node. In another embodiment of step (1), a transaction is indicated by a hash value in a digital representation.

In one embodiment of step (1), if a node determines, via the received bit-arrays or digital representations from other nodes, that at least pi portion of all nodes in the system agrees that a specific transaction is one of the submitted transactions, the node then indicates via its own new-block bit-array (or digital representation) that the specific transaction is one of the submitted transactions. In one embodiment, p₁ is set to be ⅔.

In one embodiment of step (2), the leader node builds the new block based on its own new-block digital representation (or bit-array) after step (1) is completed. Specifically, if the new-block digital representation (or bit-array) indicates a particular transaction is not among the submitted transactions, the new block built by the leader node will not include that transaction.

In one embodiment of step (2), the leader selection algorithm is based on a round-robin scheme.

In one embodiment of step (3), a node casts a yes vote on the new block received from the leader node if the block header information (pre-hash and Merkle tree root) is valid and the block body (the set of submitted transactions indicated in the new block received from the leader block) are identical to the submitted transactions received at the node.

In one embodiment of step (4), a node A determines that another node (say B) has cast a “yes” vote in the first-round of voting if at least p₂ portion of all nodes in the system has received a “yes” vote from B in the first round. Node A determines B's vote in the first round received at a node (say C) by examining the second-round vote received from C. In one embodiment, p₂ is set to ⅔.

In one embodiment of step (4), a node accepts the new block received from the leader node if at least p₃ portion of all nodes in the system has cast a “yes” vote on the new block. In one embodiment, p₃ is set to ⅔.

In one embodiment, a blockchain system accepts a transaction request coming from an entity outside the blockchain system.

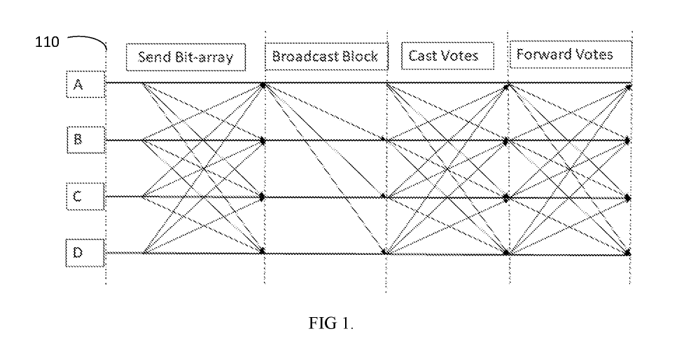

Reference is now made to FIG. 1, which is a simplified illustration showing a timeline 110 of communication between nodes in step (1), step (2), step (3), and step (4), in accordance with an exemplary embodiment. In this embodiment, 4 nodes (node A, node B, node C, and node D) are present in the blockchain system. In the timeline, the start time is on the left, and the end time is on the right, and the arrows indicate the direction of time. When step (1) (indicated in FIG. 1 as “Send Bit-array”) is executed, each node sends its initial bit-array to every other node. Specifically, node A sends its initial bit-array to nodes B, C, and D; node B sends its initial bit-array to nodes A, C, and D; node C sends its initial bit-array to nodes A, B, and D; and node D sends its initial bit-array to nodes A, B, and C. After step (1) is completed, each node (A, B, C, and D) has computed its new-block bit-array.

When step (2) (indicated in FIG.1 as “Broadcast Block”) is executed, node A (assumed to be the leader node) constructs the new block and sends the new block to B, C, and D.

When step (3) (indicated in FIG.1 as “Cast Votes”) is executed, every node validates the new block and sends its first-round vote to every other node.

When step (4) (indicated in FIG.1 as “Forward Votes”) is executed, every node sends its second-round vote to every other node.

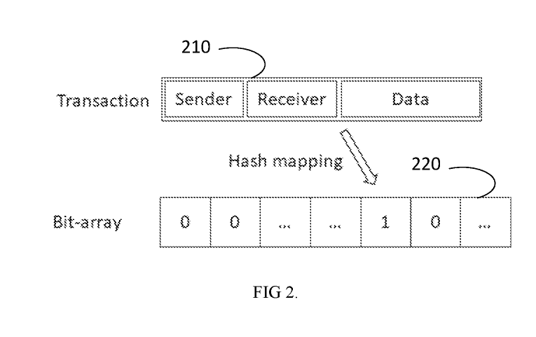

Reference is now made to FIG. 2, which is a simplified illustration showing how a node generates its initial bit-array from submitted transactions received at the node. In FIG. 2, the transaction 210 is represented by the cascade of 3 tuples: “Sender,” “Receiver,” and “Data.” The transaction is mapped via a hash function into the bit-array 220, which is indicated by the bit-sequence with binary (0 or 1) digits.

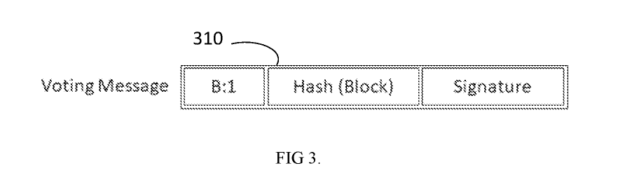

Reference is now made to FIG. 3, which is a simplified illustration of a vote message in the first-round of voting in step (3), wherein the vote message 310 is indicated by the term “Voting Message.” In FIG. 3, the vote message is generated by node B, with a “yes” vote, which is indicated by the tuple [B:1] in FIG. 3. Having validated the new block received from node A, node B includes the hash of the new block, indicated by the term “Hash (Block)” in FIG. 3. Node B also includes in the voting message 310 its digital signature, indicated by the term “Signature.”

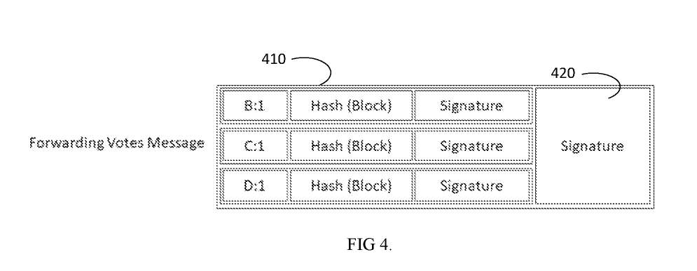

Reference is now made to FIG. 4, which is a simplified illustration of a vote message in the second-round of voting in step (4). In FIG. 4, the vote message 410 is generated by node A and is indicated by the term “Forwarding Votes Message.” In message 410, the first-round votes from nodes B, C, and D are included. In FIG. 4, the first-round vote from B is indicated by the cascade of the tuples [B:1], [Hash(Block)], and [Signature]; the first-round vote from C is indicated by the cascade of the tuples [C:1], [Hash(Block)], and [Signature]; and the first-round vote from D is indicated by the cascade of the tuples [D:1], [Hash(Block)], and [Signature]. Also included in the second-round vote message 410 is a digital signature 420 of node A, indicated by the big block labelled as “Signature” in the right most part of the drawing.

In the foregoing specification, the invention has been described with reference to specific exemplary embodiments thereof. It will, however, be evident that various modifications and changes may be made to the specific exemplary embodiments without departing from the broader spirit and scope of the invention as set forth in the appended claims. Accordingly, the specification and drawings are to be regarded in an illustrative rather than a restrictive sense.

What is claimed is:

1. A blockchain system with a plurality of system nodes, each node maintaining a blockchain of the system, the system employing a method of building or adding a new block, with the purpose of recording or accepting a set of submitted transactions which is received at least a majority of the system nodes, to the blockchain system, comprising:
Step (I): each system node generates a digital representation, the digital representation indicating all said submitted transactions received at the node, and sends the digital representation to all other system nodes;
Step (II): each system node, based on digital representations received at the node, modifies its digital representation generated in step (I), so that if at least a fixed portion of all system nodes has indicated a particular said submitted transaction, the modified digital representation at the node also indicates the particular said submitted transaction;
Step (III): a new block is built based on the modified digital representation at a system node, so that a submitted transaction is included in the new block only if it is also indicated in the modified digital representation;
Step (IV): the blockchain system adds a new block only if the new block is built in accordance with step (III).

2. The blockchain system of claim 1, wherein the said fixed portion is ⅔.

3. The blockchain system of claim 1, wherein a said submitted transaction is indicated in a said digital representation at a system node via a hash value, or via a bit in a bit-array.

4. The blockchain system of claim 3, wherein a said new block constructed in step (III) is voted for acceptance into the blockchain system in a first round of voting by a majority of system nodes, each vote from a system node submitted with a digital signature of the node.

5. The blockchain system of claim 4, wherein a second round of voting conducted by at least a majority of system nodes is used as means to accept a said new block, each said second-round vote from a system node indicating all first-round votes received at the vote-sending node.

6. A method of adding a new block to a blockchain system with a plurality of system nodes, each node maintaining a blockchain of the system, the new block being added for the purpose of recording or accepting a set of submitted transactions which is received at least a majority of the system nodes, to the blockchain system, comprising:
Step (I): each system node generates a digital representation, the digital representation indicating all said submitted transactions received at the node, and sends the digital representation to all other system nodes;
Step (II): each system node, based on digital representations received at the node, modifies its digital representation generated in step (I), so that if at least a fixed portion of all system node has indicated a particular said submitted transaction, the modified digital representation at the node also indicates the particular said submitted transaction;
Step (III): a new block is built based on the modified digital representation at a system node, so that a submitted transaction is included in the new block only if it is also indicated in the modified digital representation;
Step (IV): the blockchain system adds a new block only if the new block is built in accordance with step (III).

7. The method of claim 6, wherein the said fixed portion is ⅔.

8. The method of claim 6, wherein a said submitted transaction is indicated in a said digital representation at a system node via a hash value, or via a bit in a bit-array.

9. The method of claim 8, wherein a said new block constructed in step (III) is voted for acceptance into the blockchain system in a first round of voting by a majority of system nodes, each vote from a system node submitted with a digital signature of the node.

10. The method of claim 9, wherein a second round of voting conducted by at least a majority of system nodes is used as means to accept a said new block, each said second-round vote from a system node indicating all first-round votes received at the vote-sending node.

11. A blockchain system with a plurality of system nodes, each node maintaining a blockchain of the system, the system employing a method of building or adding a new block, with the purpose of recording or accepting a set of submitted transactions which is received at least a majority of the system nodes, to the blockchain system, comprising:
Step (I): each system node generates a digital representation, the digital representation indicating all said submitted transactions received at the node, and sends the digital representation to all other system nodes;
Step (II): each system node, based on digital representations received at the node, modifies its digital representation generated in step (I), so that if at least a fixed portion of all system node has indicated a particular said submitted transaction, the modified digital representation at the node also indicates the particular said submitted transaction;
Step (III); a new block is added to the blockchain system only if the new block is accepted through 2 rounds of voting, said to be the first and second rounds, conducted by a majority of system nodes, a vote from a system node in the first round comprising at least a yes-or-no vote on accepting the new block;
Step (IV): in the second round, a system node (say A) determines that another system node (say B) has cast a “yes” vote in the first-round if at least a fixed portion of all nodes in the system has received a “yes” vote from B in the first round, wherein node A determines B′s vote in the first round received at a node (say C) by examining the second-round vote received from C.

12. The blockchain system of claim 11, wherein the said fixed portion in step (II) is ⅔.

13. The blockchain system of claim 11, wherein a said submitted transaction is indicated in a said digital representation at a system node via a hash value, or via a bit in a bit-array.

14. The blockchain system of claim 13, wherein every vote from a system node sent to other system node includes a digital signature of the node.

15. The blockchain system of claim 14, wherein a second round of vote sent by a system node indicates all first-round votes received at the vote-sending system node.

16. The blockchain system of claim 11, wherein the said fixed portion in step (IV) is ⅔.
